(19) United States
(12) Patent Application Publication
(10) Pub. No.: US 2016/0025905 A1
(43) Pub. Date: Jan. 28, 2016

(54) Low Refractive Index Coating With Fluroelastomer Encapsulated Glass Bubbles

(71) Applicant: WhiteOptics LLC, New Castle, DE (US)

(72) Inventors: Eric Teather, Elkton, MD (US); Matt Urban, Severna Park, MD (US); Alex Gidumal, Newark, DE (US)

(73) Assignee: WhiteOptics LLC, New Castle, DE (US)

(21) Appl. No.: 14/740,227

(22) Filed: Jun. 15, 2015

Related U.S. Application Data
(60) Provisional application No. 62/011,901, filed on Jun. 13, 2014.

(51) Int. Cl. G02B 5/02; F21K 99/00

(52) U.S. Cl. CPC G02B 5/0242; G02B 5/0278; F21K 9/58

(57) ABSTRACT

A coating composite material spray applied to a lens that is capable of transmitting light, with little loss, diffusively through the coated lens located near a light source, particularly in an LED lighting application. The coating material is formed from a polyurethane mixed with fluoroelastomer encapsulated glass bubbles and will allow for high diffusion, while also maintaining high transmission when applied to a lens near a lighting application, particularly LED fixture lenses.

### BACKGROUND OF THE INVENTION

1. Field of Invention

This disclosure relates to diffusion coatings for lenses for lighting applications, particularly LED-based light assemblies, and lighting fixtures including the same.

2. Description of the Related Art

Light emitting diodes (LEDs) consume considerably less power than incandescent light bulbs, making them desirable replacement in the effort to increase efficiency and conserve energy consumption. To increase the luminosity of LEDs, lenses are placed in front of them, which focuses the light into a beam that is essentially perpendicular to the LED junction base. Inevitably, light dispersion from the LED is decreased, which limited the use of LEDs to specialized illumination applications until recent improvements in LED light diffusion/dispersion permitted them to be used in environmental and task lighting. LEDs have many advantages over incandescent light sources including lower energy consumption, longer lifetime, improved physical robustness, smaller size, and faster switching. The light distribution characteristic of LEDs is significantly different from that of a traditional incandescent or wire filament-based light fixture. LEDs used in lighting fixtures do not emit light in all directions, i.e., 360 degrees. A flat-surface uncoated LED semiconductor chip will, as noted above, emit light only perpendicular to the semiconductor's surface, and a few degrees to the side. Thus the light cone emitted from an LED is relatively narrow compared to traditional light fixtures.

To increase the irradiation angle of LED light fixtures, diffusion lenses have been utilized, including that disclosed in U.S. Pat. No. 6,361,192 to Fussell et al. and U.S. Pat. No. 8,641,231, to Ariyoshi et al. These diffusion lenses of the prior art have drawbacks, however, including light transmission loss, high cost of materials, manufacturing complexities and limited diffusion performance.

Coatings that are diffusely effective rather than transmissive, have been developed for LED lighting applications in order to avoid light loss by absorption into lighting fixture cavities. These include polyurethane diffusion coatings as disclosed in commonly owned patents issued as, U.S. Pat. Nos. 8,734,940; 8,517,570; and 8,361,611, each of which is expressly incorporated herein by reference. These diffuse reflective coatings, however, are engineered to maximize the reflection, i.e., bounce back of light, into the direction and area of desired illumination, not to allow for the transmission, i.e., penetration, of light through the coating, albeit in a diffuse, i.e., less concentrated, light pattern.

A need therefore exists for a relatively inexpensive composite material that is relatively inexpensive to manufacture and apply and that is highly diffuse and thermodynamically resilient and stable, but also maintains high transmission when operating as a lens in an LED light fixture.

### SUMMARY OF THE INVENTION

It would be desirable to have a simple, economical means to provide diffusive transmission of concentrated light through a lens or other form of diffuser film surface near a lighting application, which would avoid the problems inherent in know light diffusers, particularly cost of materials and complexity to manufacture and the loss of light associated with conventional diffuser technology.

In one aspect, a low refractive index polyurethane diffusion coating is disclosed that incorporates fluoroelastomer encapsulated glass bubbles or hollow microspheres, which form a highly diffuse, thermodynamically stable composite material that maintains high transmission capability when applied to a lighting fixture lens, particularly an LED fixture.

### BRIEF DESCRIPTION OF THE DRAWINGS

FIG. 1 is a graph of light output measured over time from a Sylvania RT4 downlight, showing increased output for C19 HD coating with fluoroelastomer as compared to C19 HD coating without fluoroelastomer.

FIG. 2 is a photographic display of equal levels of diffusion for sprays to acrylic. Output values are shown in Table 2.

FIG. 3 is a graph of diffusion profiles. All coatings are 1.5 mils thickness and applied to acrylic lenses. Output is shown in Table 2 and images are shown in FIG. 4.

FIG. 4 is a collection of photographic images illustrating the diffusion patterns of the coatings applied to acrylic lenses graphed in FIG. 3 and listed in Table 2.

FIG. 5 is a collection of photographic images illustrating the diffusion patterns for coatings applied to glass lenses. Output is listed in Table 2.

### DETAILED DESCRIPTION OF THE INVENTION

According to one preferred embodiment of the present invention, a highly light transmissive, thermodynamically stable polyurethane coating was created by incorporating hollow glass bubbles or microspheres encapsulated by fluoropolymer, particularly fluoroelastomer. The polyurethane and coated bubbles mixture is then applied to a lens surface near an LED lighting source. The resultant lens coatings demonstrated high diffusion properties for the composite material while maintaining high light transmission values when function in conjunction with an LED light fixture with a glass or acrylic lens surface.

Two polyurethane dispersion coatings to be applied to the lens surface were created. The first dispersion coating consisted of a polyurethane and glass bubble mixture, referred to in the tables and figures that follow as “C19 HD” or “HD baseline”. The second dispersion coating was a mixture of polyurethane, glass bubbles and fluoropolymer (“FP”), and is referred to in the tables and figures that follow as “C19 HDv2” or as the “fluoroelastomer” coat. For both dispersion coatings, glass bubbles with a median diameter 15 microns were used. For the second, or C19 HDv2, dispersion coating, the fluoropolymer coat weight was calculated using the volume of the average sized glass bubble and densities of the fluoropolymer and glass bubbles. A preferred fluoropolymer is a fluoroelastomer by DuPont called Viton 200GS. This fluoropolymer was suspended in acetone at 2% weight.

A calculated coat weight of 2% fluoropolymer solution was added to solution of the acetone/glass bubbles mixture and the acetone was allowed to evaporate while mixing in order to allow the fluoropolymer to remain coated to the glass bubbles. Water was added during evaporation to maintain fluidity of the glass bubble solution and to prevent conglomeration of the fluoropolymer coated bubbles. Because the fluoropolymer is insoluble in water, it remains coated to the glass bubbles as the acetone evaporates. The total coating was then mixed.

The concentrations of bubbles in the mixtures were the same for both types of dispersion coatings. Upon observation under a microscope of both the HD baseline (C19 HD) and fluoropolymer (C19 HDv2) dispersion coatings, a slight blur to the edges of the glass bubbles was observed in the fluoropolymer (C19 HDv2) dispersion coating mixture.

The dispersion coatings were sprayed onto glass or acrylic lens surfaces for light transmission and diffusion analysis. Thickness was measured by caliper versus pre-sprayed part when reported. All tests were performed with a Sylvania RT4 9 W downlight and acrylic and glass lenses cut to size. Diffusion was measured through a brightness analyzer. The most ideal diffuse surface would emit the same intensity of light across the entire surface area. The wider the center peak, the more diffuse the surface.

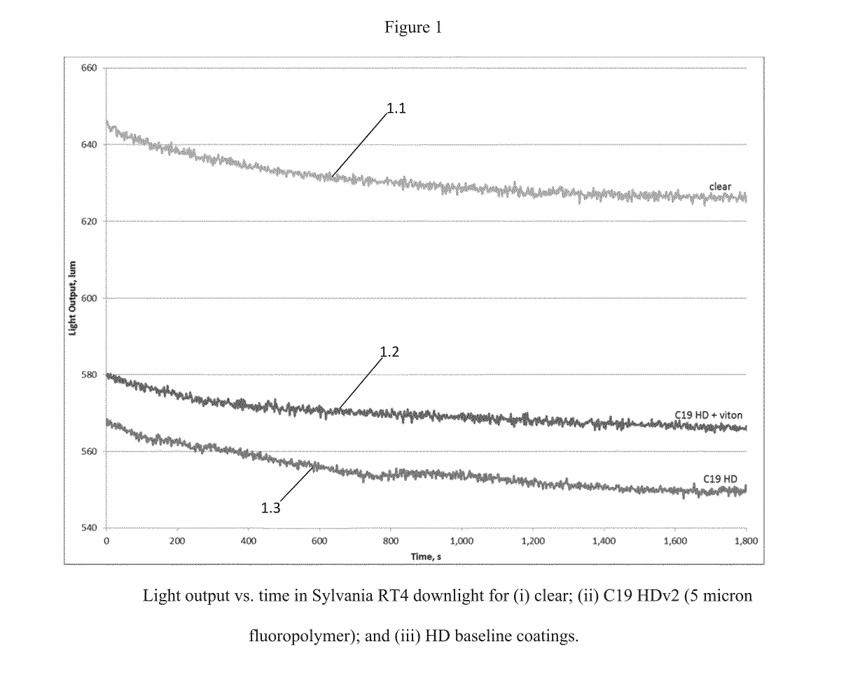

The light output or light intensity through the dispersion coated lenses was measured in two similar ways: (i) “White Room” and (ii) “Globe”. In the “White Room” measurement technique, the room is covered in 98% reflective material and an optical sensor is place on one wall covered with 98% reflective baffle, so as to prevent direct light and only detect reflected light. A downlight is set on the floor facing up. Luminous output is measured by sensor over time. Downlight decreases output as heat is generated, so values are recorded after output has become level. The leveling of light output over time is in FIG. 1.

In the “Globe” technique, a hollow, plastic sphere is used. The sphere is a three feet in diameter and is coating with a WhiteOptics C18 95+% reflective coating and a 97% reflective baffle. Downlight is set into hole at top of globe. A light meter then detects luminous flux at the hole in the globe behind baffle.

FIG. 1 illustrates light output over time for three analyzed lens surfaces, as a measured for a Sylvania RT4 downlight behind the lens. The top line 1.1 shows the output through a clear, uncoated lens surface. The middle line 1.2 shows the output through a fluoropolymer (C19 HDv2) dispersion coated lens. The bottom line 1.3 shows the output through the HD baseline (C19 HD) dispersion coated lens. The calculated hymens and percent loss measured for each of these three lens surfaces is listed in the Table 1 below.

TABLE 1
Luminous Flux output for varying lenses, Sylvania RT4 downlight,
white room method.

| Lens | Lumens | Loss° |
|---|---|---|
| Clear | 625.8 | 0.00% |
| C19 HD | 549.5 | 12.19% |
| 5 micron fluoroelastomer | 565.9 | 9.57% |
| coat (C19 HDv2) | | |

As illustrated by the graph in FIG. 1, and shown by the calculated measurements in Table 1, the 5 micron fluoropolymer (C19 HDv2, 5 micron) dispersion coating 1.2 allowed for better light transmission output, as compared to the HD baseline (C19 HD) coating 1.3, or stated another way, less loss of transmitted light was observed for 5 micron fluoropolymer (C19 HDv2, 5 micron) dispersion coating.

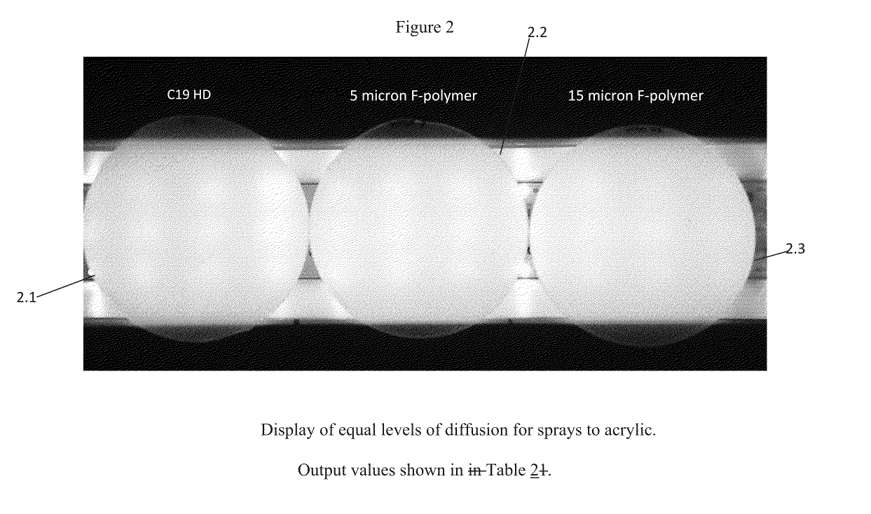

FIG. 2 is a photographic illustration displaying equal levels of diffusion for dispersion coating sprays to an acrylic lens with: (i) HD baseline (C19 HD) 2.1; (ii) 5 micron fluoropolymer (C19 HDv2, 5 micron) 2.2; and (iii) 15 micron fluoropolymer (C19 HDv2, 15 micron) 2.3.

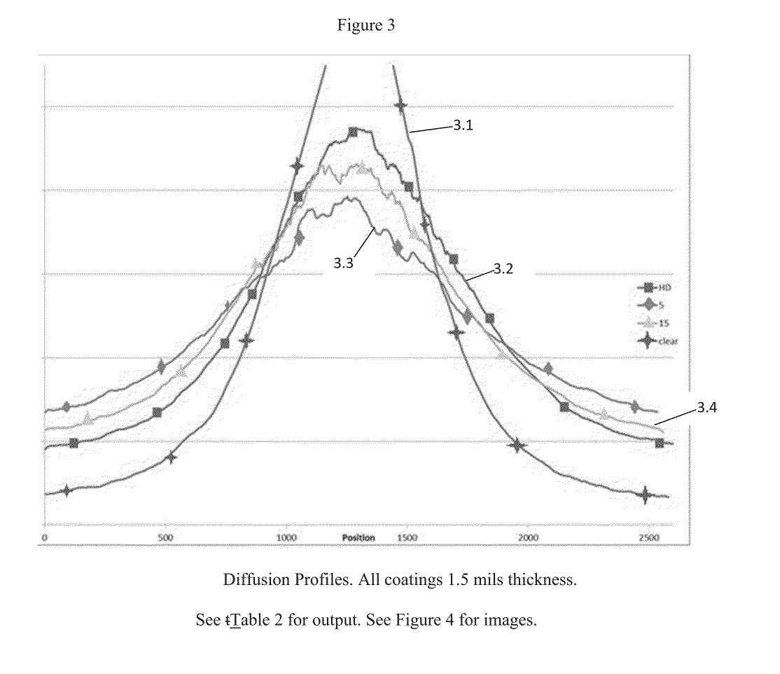

FIG. 3 is a graphical illustration of the diffusion profiles measured for four different acrylic lens surfaces: (i) a HD baseline (C19 HD) coated 3.2; (ii) a 5 micron fluoropolymer (C19 HDv2, 5 micron) coated 3.3; (iii) a 15 micron fluoropolymer (C19 HDv2, 15 micron) coated 3.4; and (iv) a clear, uncoated lens 3.1. Each of the measured surfaces had an applied coating thickness of 1.5 mils on the acrylic lens surface except, of course, the uncoated lens surface.

As noted above, ideal diffusion would emit the same intensity of light across the entire surface area. This would result in a horizontal straight line as its diffusion profile as compared to the other, non-ideal, diffusion profiles shown in FIG. 3. The wider the center peak, or in other words, the flatter the line, the more diffuse the surface. In FIG. 3, the diffusion profile for C19 HDv2 fluoroelastomer dispersion coating, wherein the glass bubbles had a 5 micron coating of fluoroelastomer 3.3, is shown to have the widest center peak, i.e., the flattest line. The 15 micron coating 3.4 shows better diffusion than the HD baseline coating, which demonstrates better diffusion than the uncoated, clear lens 3.1 showing the highest center peak. Thus, the 5 micron coating 3.3 demonstrated the best diffusion properties of the various analyzed lens surfaces.

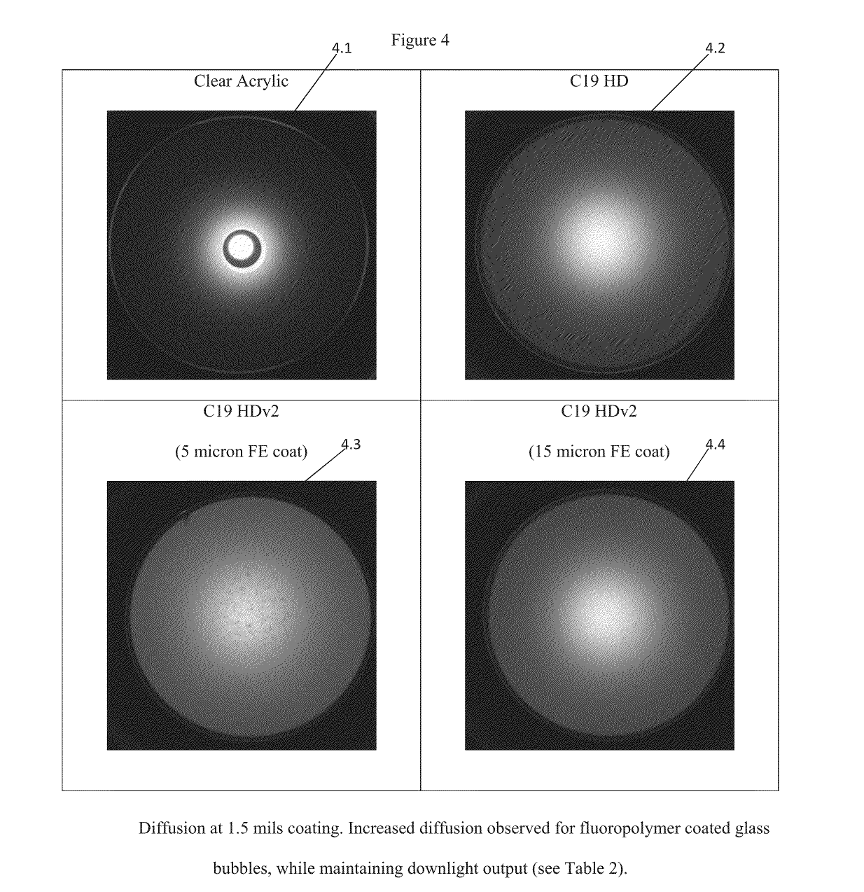

FIG. 4 shows photographic images of the four lens surfaces graphically illustrated in FIG. 3. Notably, markedly better diffusion is observable from these images for the fluoropolymer coated glass bubble coatings. In particular, the 5 micron fluoropolymer (C19 HDv2, 5 micron) coating 4.3 (bottom left) illustrates the best/broadest diffusion better; the 15 micron fluoropolymer (C19 HDv2, 15 micron) coating 4.4 (bottom right) illustrates the next best pattern. The top row of FIG. 4 shows non-diffusion for the clear acrylic lens 4.1 (top left) and a diffusion pattern for HD the baseline coating 4.2 (top right) that is less diffuse than the fluoropolymer coatings shown in the bottom row.

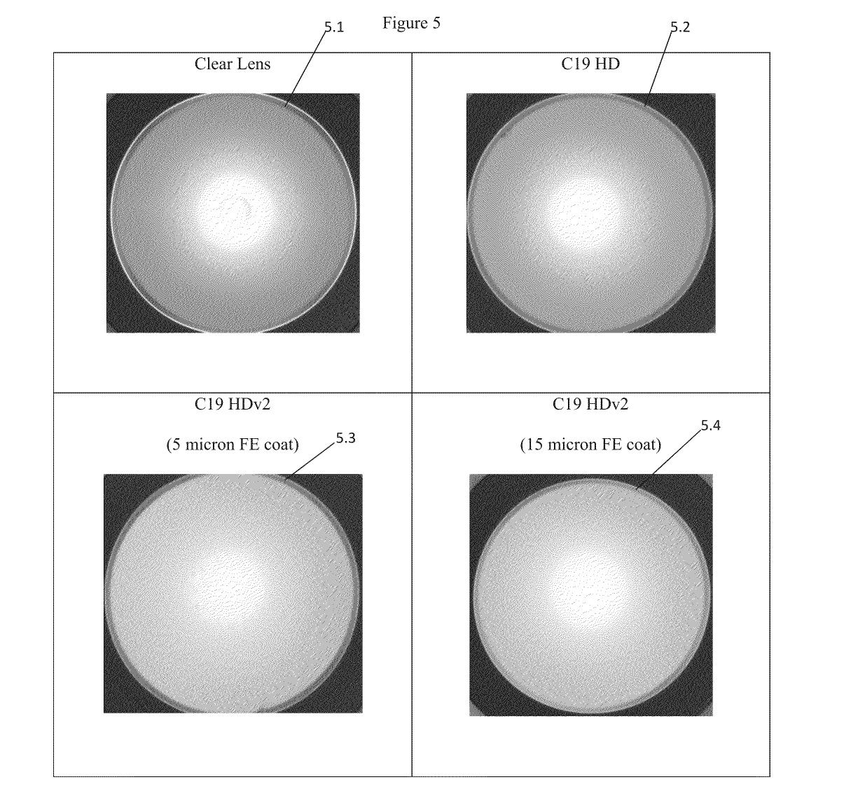

FIG. 5 shows another set of photographic images of four lens surfaces: (i) a clear, uncoated lens 5.1 (top left); (ii) a HD baseline (C19 HD) coated 5.2 (top right); (iii) a 5 micron fluoropolymer (C19 HDv2, 5 micron) coated 5.3 (bottom left); and (iv) a 15 micron fluoropolymer (C19 HDv2, 15 micron) coated 5.4 (bottom right). For each of these surfaces, and the lens surface images shown in FIG. 4, the measured lumens and percent loss values are tabulated in Table 2.

TABLE 2
9W Sylvania RT4 downlight output, globe method.

| Type | Lens | Lumens | Loss° | Δ baseline |
|---|---|---|---|---|
| spray to | Clear | 593.1 | 0.00% | |
| equal | HD baseline | 540.2 | 8.91% | |
| diffusion | 5 micron Fluoroelastomer | 555.0 | 6.42% | 2.50% |
| (glass) | Coat | | | |
| | 15 micron | 556.1 | 6.24% | 2.67% |
| | Fluoroelastomer Coat | | | |
| 1.5 mils | HD baseline | 579.3 | 2.32% | |
| spray | 5 micron Fluoroelastomer | 578.3 | 2.50% | −0.18% |
| (acrylic) | Coat* | | | |
| | 15 micron | 580.4 | 2.14% | 0.18% |
| | Fluoroelastomer Coat* | | | |

*markedly better diffusion
°±.30%

As is notable from Table 2, less light output loss was observed (at least 2.5% less) for the light passing through the fluoropolymer coating sprayed on the glass lens to an equal diffusion level (FIG. 5). Moreover, for the 1.5 mil coating applied to an acrylic lens, loss of 2.5% or less was measured for the fluoropolymer coating while the diffusion patterns shown in FIG. 4 for these coatings were markedly better than the HD baseline.

While the foregoing has been described in sonic detail for purposes of clarity and understanding, it will be appreciated by one skilled in the art from a reading of this disclosure that various changes in form and detail can be made without departing from the true scope of the invention and appended claims. All patents and publications cited herein are entirely incorporated herein by reference.

That which is claimed:

1. A low refractive index diffusion coating, comprising:
Polyurethane, and
glass bubbles dispersed within the polyurethane, wherein the glass bubbles are fully and encapsulated with a fluoropolymer.

2. The coating of claim 1, wherein the diffusion coating is applied to a lens.

3. The coating of claim 2, wherein the lens is acrylic or glass.

4. The coating of claim 2, wherein the lens is proximate a light source.

5. The coating of claim 4, wherein the light source is a light-emitting diode (LED).

6. The coating of claim 1, wherein the thickness of the diffusion coating is at least about 1.5 mils.

7. The coating of claim 1 wherein the fluoropolymer is a fluoroelastomer.

8. The coating of claim 1, wherein the fluoropolymer encapsulating the glass bubbles is between about 5 and about 15 microns in thickness.

9. The coating of claim 1, wherein the fluoropolymer coating is about 5 microns in thickness.

10. The coating of claim 11, wherein the fluoropolymer coating is about 15 microns in thickness.

11. The coating of claim 2, wherein the lens is acrylic.

12. The coating of claim 2, wherein the lens is glass.

13. The coating of claim 5 and claim 11, wherein the measurable degree of loss of light from the light source passing through the acrylic lens is 2.5% or less.

14. The coating of claim 5 and claim 12, wherein the measurable degree of loss of light from the tight source passing through the glass lens is 6.4% or less.

15. A method improving efficiency and usability of light from an LED light source, comprising:
introducing light from the light source to a coating of about 1.5 mil thickness applied to an acrylic lens proximate the light source, wherein the coating comprises a mixture of polyurethane and fluoroelastomer encapsulated glass bubbles dispersed with the polyurethane;
refracting a portion of the light as it reaches the boundaries between; (i) air and the lens; (ii) the lens and polyurethane; (iii) the polyurethane and fluoroelastomer; (iv) the fluoropolymer and glass bubble; (v) the glass bubble and air inside the bubble; and (vi) the polyurethane and air;
diffusing the light across the coating as it is refracted;
transmitting the light through the coating with less than ten percent loss.
